(19) United States
(12) Patent Application Publication
(10) Pub. No.: US 2012/0319868 A1
(43) Pub. Date: Dec. 20, 2012

(54) Pedestrian crossing signal system

(76) Inventor: Andrew S. Kupczyn, Atco, NJ (US)

(21) Appl. No.: 13/134,711

(22) Filed: Jun. 15, 2011

(51) Int. Cl. G08G 1/095

(52) U.S. Cl. 340/944

(57) ABSTRACT

A pedestrian crossing signal system utilizes two signaling stations, one to be positioned at each end of a crosswalk on a roadway. Each station utilizes a tower of appropriate height, e.g. eight feet, having a high powered signal strobe light mounted at the top of the tower. A push button actuator turns on the strobe light. Electricity for powering the light is derived from a battery mounted within a compartment in the base of the tower. A solar panel provides energy to continually charge the battery. When the actuating button is pushed by a pedestrian, the strobe light is turned on providing immediate and clear notice to oncoming vehicular traffic of the presence of a pedestrian at the end of the crosswalk.

### BACKGROUND OF THE INVENTION

Pedestrian crosswalks are painted on roadway surfaces both for the safety of pedestrians and to provide notice to motorists of pedestrians in these safety zones. However, crosswalk lines, being located on the roadway surfaces, are often not seen by motorists, especially during dawn, dusk, or nighttime hours. In fact, motorists sometime fail to observe pedestrians crossing the roadway at all, either because of poor lighting or inattention.

This problem is somewhat alleviated by traffic light systems having “Walk/Don't Walk” signals. However, these systems are usually located only at major intersections. A pedestrian desiring to cross a busy street having a crosswalk but no other means to provide notice of the crossing to vehicular traffic, is at the mercy of the inattentive motorist.

### SUMMARY OF THE INVENTION

It is thus the object of the present invention to provide a pedestrian crossing signal system which squarely addresses the issue of pedestrian safety at crosswalks.

It is the object of the present invention to provide a pedestrian crossing signal system which utilizes dual signaling stations, one station located at opposite ends of a crosswalk, to provide notice to vehicular traffic of the presence of pedestrians.

It is another object of the present invention to provide a pedestrian crossing signal system in which its signaling stations comprise high towers with high powered solar energized strobe lights, to provide clear notice to oncoming traffic of the presence of pedestrians who are crossing from one end of the intersection to the other.

It is a further object of the present invention to provide a pedestrian crossing signal system which is relative simple in design, has few components, and is thus economical to manufacture and install.

These and other objects are accomplished by the present invention, a pedestrian crossing signal system comprising two signaling stations, one to be positioned at each end of a crosswalk on a roadway. Each station utilizes a tower of appropriate height, e.g. eight feet, having a high powered signal strobe light mounted at the top of the tower. A push button actuator turns on the strobe light. Electricity for powering the light is derived from a battery mounted within a compartment in the base of the tower. A solar panel provides energy to continually charge the battery. When the actuating button is pushed by a pedestrian, the strobe light is turned on providing immediate and clear notice to oncoming vehicular traffic of the presence of a pedestrian at the end of the crosswalk.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the pedestrian crossing signal system of the present invention in use at the opposite ends of a crosswalk.

FIG. 2 shows one signaling station of the pedestrian crossing signal system of the present invention.

FIG. 3 is a detailed view of the base section of the signaling station of the pedestrian crossing signal system of the present invention.

FIG. 4 is a schematic representation of the electrical operation of the pedestrian crossing signal system of the present invention.

### DETAILED DESCRIPTION OF THE INVENTION

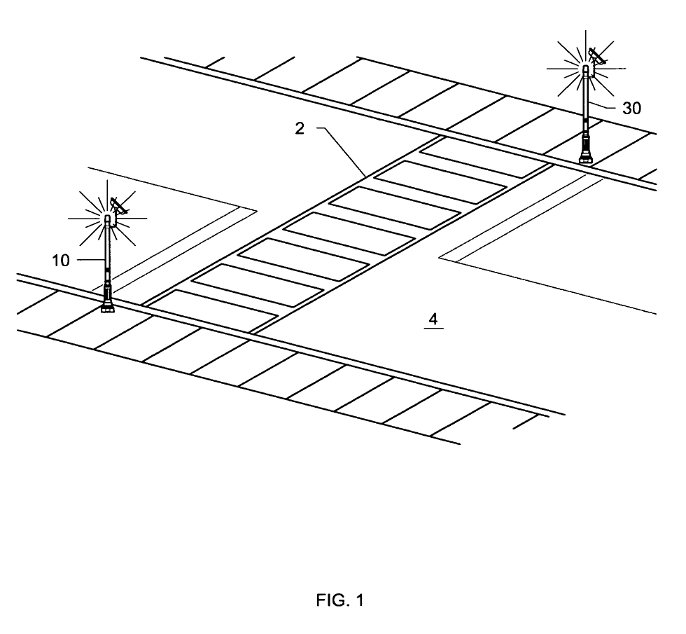

It is contemplated that the pedestrian crossing signal system of the present invention will be located on vehicular trafficked roads and streets where there are no traffic lights, signs, or other pedestrian assisting aids. The present system provides such an aid by utilizing two signaling stations 10 and 30, positioned at opposite ends of crosswalk 2, located across road surface 4. See FIG. 1.

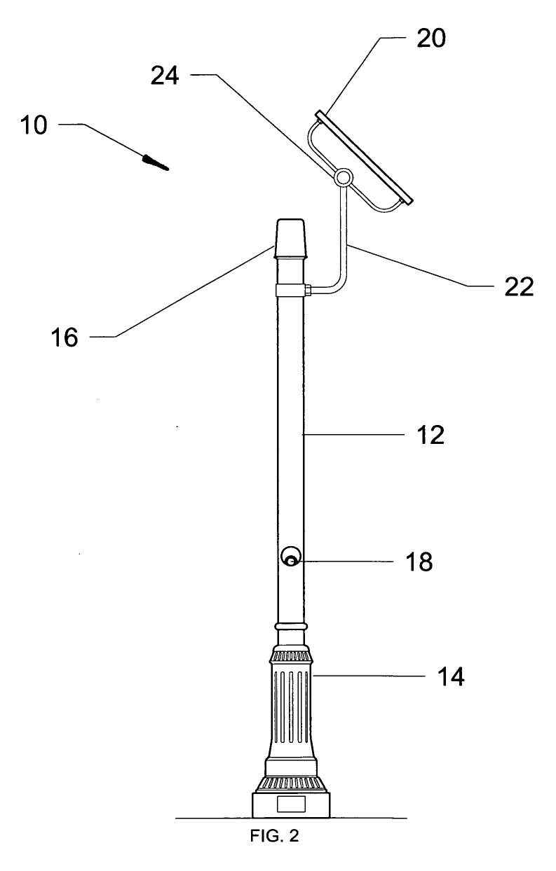

FIG. 2 shows representative signaling station 10 comprising tower 12. Tower 12 is designed to be high enough to be easily seen by passing motorists, e.g. eight feet in height. The tower is an elongated post made of aluminum or high grade amber plastic. It is noted that the height and construction material of tower 12 are disclosed as examples only, and the invention should not be deemed restricted to these parameters. The tower for signaling station 30 is identical to tower 12.

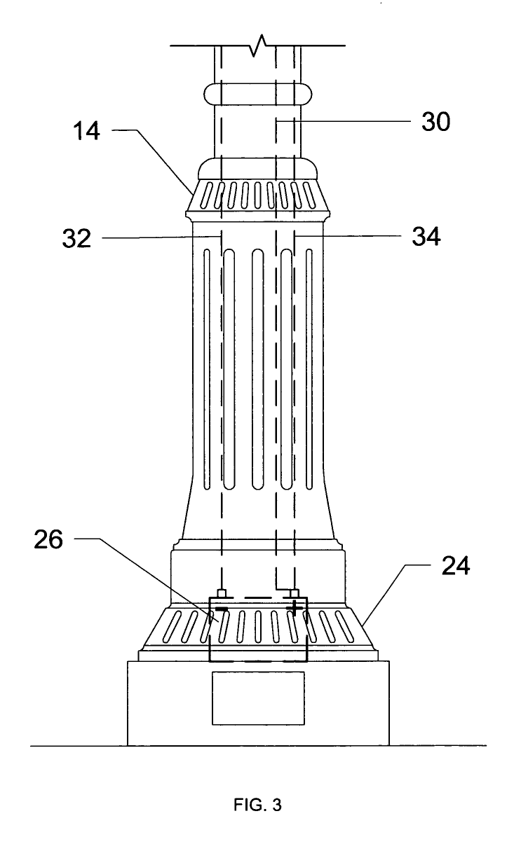

Tower 12 comprises base section 14 which maintains the tower at the end of the crosswalk, high powered strobe light 16 mounted atop the tower, push button timer switch 18, and solar panel 20 secured to the upper section of tower by supporting bracket 22. Solar panel is adjustably and rotatably mounted to bracket 22 at 24, to allow angular adjustment. Base section 14 comprises compartment 24 in which electric battery 26 is located, as best seen in FIG. 3.

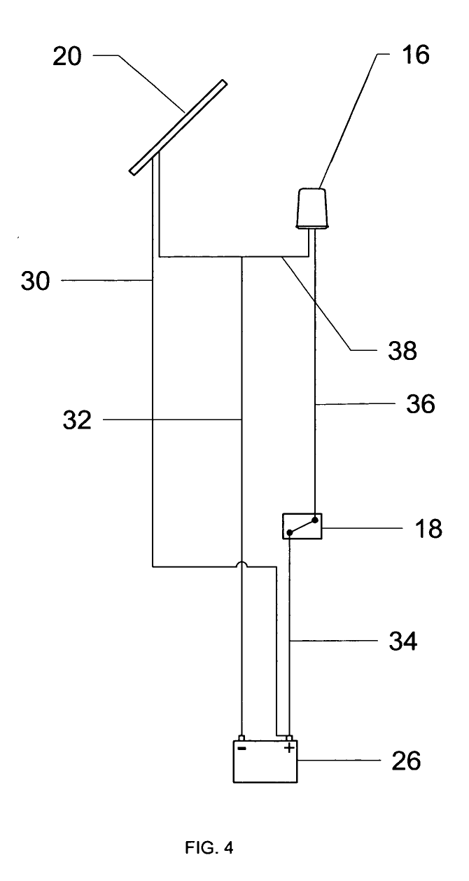

FIG. 4 schematically shows the circuitry of the components of the inventive system. Solar panel 20 provides energy through electrical lines 30 and line 32 to charge battery 26, which in turn produces electricity through electrical lines 34, 36, and 38. Push button timer switch 18 actuates the system.

Upon entering crosswalk 2, a pedestrian presses push button 18 which actuates and turns on strobe light 16. Battery 26, continually being charged by solar panel 20, provides the electrical power to strobe light 16. Once illuminated, strobe light 16 constitutes a high powered bright light source, atop tower 12, providing clear, visual notification to oncoming vehicular traffic. Motorists approaching the crosswalk will immediately see this bright light. Their attention will automatically be directed towards strobe light 16, where they will also immediately observe the crossing pedestrian and take appropriate safety measures.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A pedestrian crossing signal system for placement at the opposite ends of a crosswalk located across a vehicular trafficked roadway, said system comprising:
two signaling stations, one positioned at each end of the crosswalk, each station comprising:
a tower having a high powered signal light, actuating means for turning on the signal light, electrical means for powering the signal light, and solar energy receiving means for charging the electrical means, whereby upon activation of the actuating means of one of the towers that tower's signal light is turned on, providing visual notification to vehicular traffic of a pedestrian entering and crossing the crosswalk at the end of the crosswalk on which the lighted tower is located.

2. The pedestrian crossing signal system as in claim 1 wherein the actuating means is a push button located on each tower.

3. The pedestrian crossing signal system as in claim 1 wherein the solar energy means comprises an adjustable solar panel secured to the upper section of each tower.

4. The pedestrian crossing signal system as in claim 1 wherein the electrical means is a battery located within a compartment in a base section of each tower.

5. The pedestrian crossing signal system as in claim 1 wherein the high-powered signal light comprises a strobe light located atop each tower.
